(19) United States
(12) Patent Application Publication
(10) Pub. No.: US 2005/0057781 A1
(43) Pub. Date: Mar. 17, 2005

(54) Digital communications terminal and digital communications method

(76) Inventor: Tomohito Kajiwara, Tokyo (JP)

Correspondence Address: COOPER & DUNHAM, LLP, 1185 AVENUE OF THE AMERICAS, NEW YORK, NY, 10036, US

(21) Appl. No.: 10/940,916

(22) Filed: Sep. 14, 2004

(30) Foreign Application Priority Data
Sep. 16, 2003 (JP) 2003-323119

(51) Int. Cl. H04N 1/00

(52) U.S. Cl. 358/400

(57) ABSTRACT

A digital communications terminal is disclosed in which, when packet loss occurs at a time of receiving multiple packets into which a single frame of information is divided, the received packets are discarded when the last one of the packets is received.

### BACKGROUND OF THE INVENTION

1. Field of the Invention

The present invention relates generally to digital communications terminals and digital communications methods, and more particularly to a terminal such as a network facsimile device and a method that perform digital communications using UDP (User Datagram Protocol).

2. Description of the Related Art

Some of those terminals compliant with ITU-T Recommendation T.38 transmit a signal that is transmitted in a single frame by a G3 (Group 3) facsimile device, such as a DIS (Digital Identification Signal: a signal used for a terminal to report its standard transmission function), by dividing the signal into units of several bytes.

Japanese Laid-Open Patent Application No. 2001-197279 discloses a real-time Internet facsimile device connected to a computer network to transmit a facsimile image by packet communications, where the number of redundant packets transmitted in the case of using UDP as a network transport can be changed optionally during communications.

In ITU-T Recommendation T.38-compliant terminals that transmit a signal that is transmitted in a single frame by a G3 facsimile device, such as a DIS, by dividing the signal into units of several bytes, if packet loss occurs in the case of transmitting a signal frame divided into packets in UDP communications, the following problem arises.

That is, if a single frame is assembled by connecting the transmitted divided packets ignoring a lost packet, this frame turns into a DIS signal in which a byte string after the lost packet is different from a correct byte string, thus causing communication error.

### SUMMARY OF THE INVENTION

It is a general object of the present invention to provide a digital communications terminal and a digital communications method in which the above-described disadvantage is eliminated.

A more specific object of the present invention is to provide a digital communications terminal and a digital communications method that can perform normal communications even when packet loss occurs.

The above objects of the present invention are achieved by a terminal performing digital communications, wherein when packet loss occurs at a time of receiving a plurality of packets into which a single frame of information is divided, the received packets are discarded when a last one of the packets is received.

The above objects of the present invention are also achieved by a terminal performing digital communications, wherein when packet loss occurs, at a time of receiving a plurality of packets into which a single frame of information is divided, after receiving a first one of the packets, the received packets are discarded when a last one of the packets is received.

The above objects of the present invention are also achieved by a terminal performing digital communications, wherein when there is a possibility, at a time of receiving a plurality of packets into which a single frame of information is divided, of occurrence of loss of an initial packet of the frame, a first one of the received packets is checked and if the first one of the received packets is not the initial packet of the frame, the received packets are discarded.

The above objects of the present invention are also achieved by a method of performing digital communications in which a single frame of information is communicated in a plurality of packets, the method including the steps of: (a) successively receiving the packets of the frame; (b) storing the received packets; (c) determining whether there is occurrence of packet loss during step (a); (d) determining whether a lost packet is recoverable from redundant packets attached to a rest of the packets when step (c) determines that there is the occurrence of the packet loss during step (a); and (e) discarding the stored packets at a time of receiving a last packet of the frame when step (d) determines that the lost packet is unrecoverable from the redundant packets attached to the rest of the packets.

According to the above-described inventions, communications can be performed normally even when packet loss occurs.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a communications network system according to a first embodiment of the present invention;

FIG. 2 is a schematic block diagram showing a configuration of a terminal according to the first embodiment of the present invention;

FIG. 3 is a diagram showing a packet structure according to the first embodiment of the present invention;

FIG. 4 is a diagram showing a case of transmitting a facsimile signal in multiple packets according to the embodiment of the present invention;

FIG. 5 is a diagram showing a communications sequence of the communications network system according to the embodiment of the present invention;

FIG. 6 is a flowchart showing part of the operations flow of a terminal at the time of packet reception according to the first embodiment of the present invention; and

FIG. 7 is a flowchart showing part of the operations flow of a terminal at the time of packet reception according to a second embodiment of the present invention.

### DETAILED DESCRIPTION OF THE PREFERRED EMBODIMENTS

A description is given, with reference to the accompanying drawings, of embodiments of the present invention.

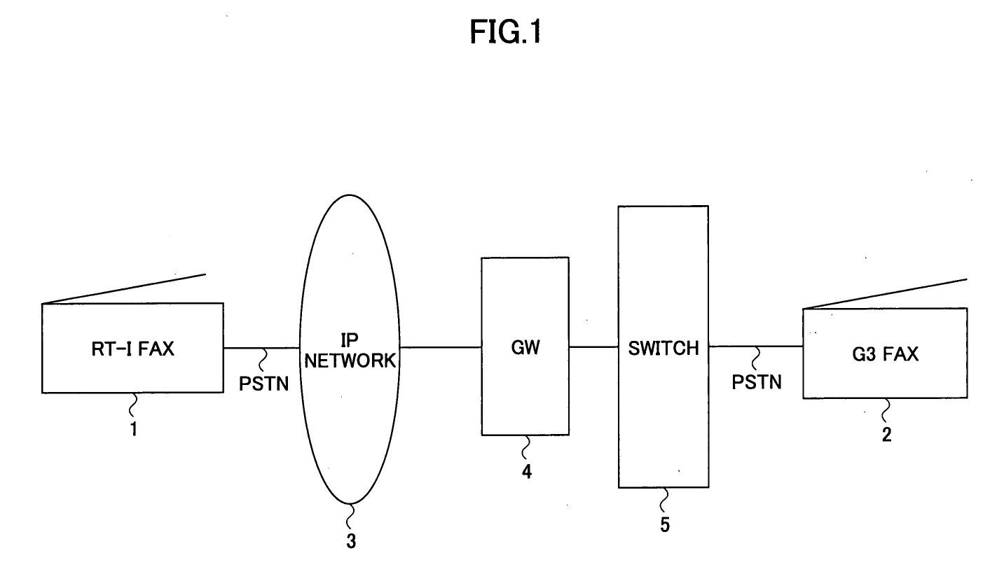

FIG. 1 is a diagram showing a communications network system according to a first embodiment of the present invention. The communications network system of FIG. 1 includes a real-time Internet facsimile device (RT-I FAX) 1 as an ITU-T Recommendation T.38-compliant terminal and a G3 facsimile device (G3 FAX) 2. The real-time Internet facsimile device 1 and the G3 facsimile device 2 perform facsimile communications with each other through a public network (PSTN: Public Switched Telephone Network), an IP (Internet Protocol) network 3, a gateway (GW) 4, a switch 5 (for instance, an NTT switch), and a public network (PSTN). The IP network 3 supports IP, which is the standard protocol of the Internet. The gateway 4 performs conversions between communications networks based on VOIP (Voice over Internet Protocol)

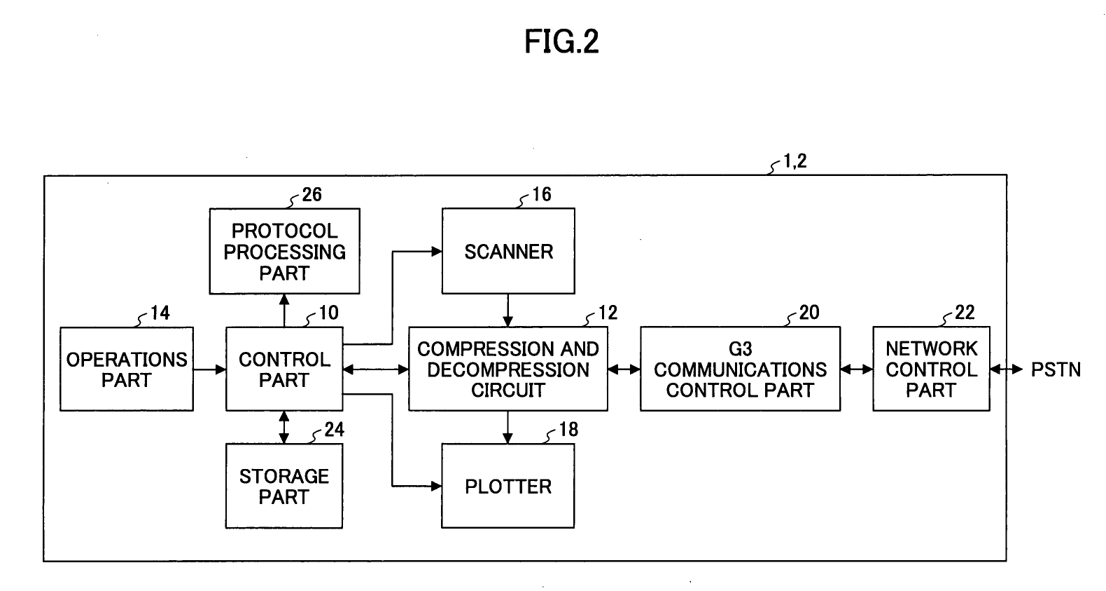

FIG. 2 is a schematic block diagram showing a configuration of each of the real-time Internet facsimile device 1 and the G3 facsimile device 2. Each of the real-time Internet facsimile device 1 and the G3 facsimile device 2 includes a control part 10 controlling the entire device 1 or 2, a compression and decompression circuit 12 compressing and decompressing image information, an operations part 14 on which a user performs a variety of operations, a scanner 16 reading the image of an original and outputting image information, a plotter 18 printing image information, a G3 communications control part 20 controlling communications of image information, and a network control part 22 enabling the G3 communications control part 20 to perform communications of image information with a counterpart terminal via the public network (PSTN). The image information from the scanner 16 is compressed in the compression and decompression circuit 12 to be transmitted through the G3 communications control part 20 and the network control part 22 to the counterpart terminal via the public network (PSTN). Image information is received from the counterpart terminal through the network control part 22 and the G3 communications control part 20 via the public network (PSTN). Then, the received image information is decompressed in the compression and decompression circuit 12, and thereafter, is printed by the plotter 18.

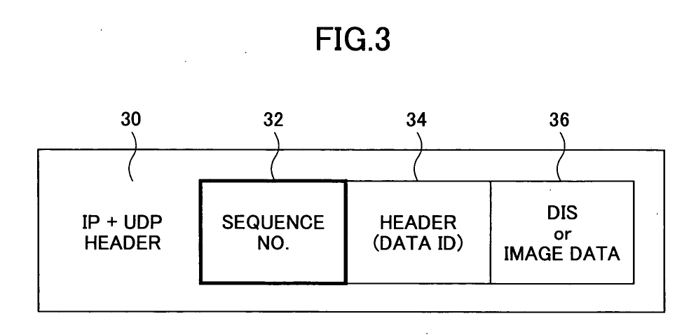

The system of FIG. 1 performs digital communications using UDP. In the UDP communications, packets into which a single HDLC (High level Data Link Control) frame is divided are transmitted and received. FIG. 3 is a diagram showing a structure of each packet. As shown in FIG. 3, the packet is compliant with ITU-T Recommendation T.38, and includes an IP+UDP header 30, a sequence number 32, a header (data ID) 34, and a DIS signal or image data 36. Further, previously transmitted multiple packets are attached to the packet as redundant packets.

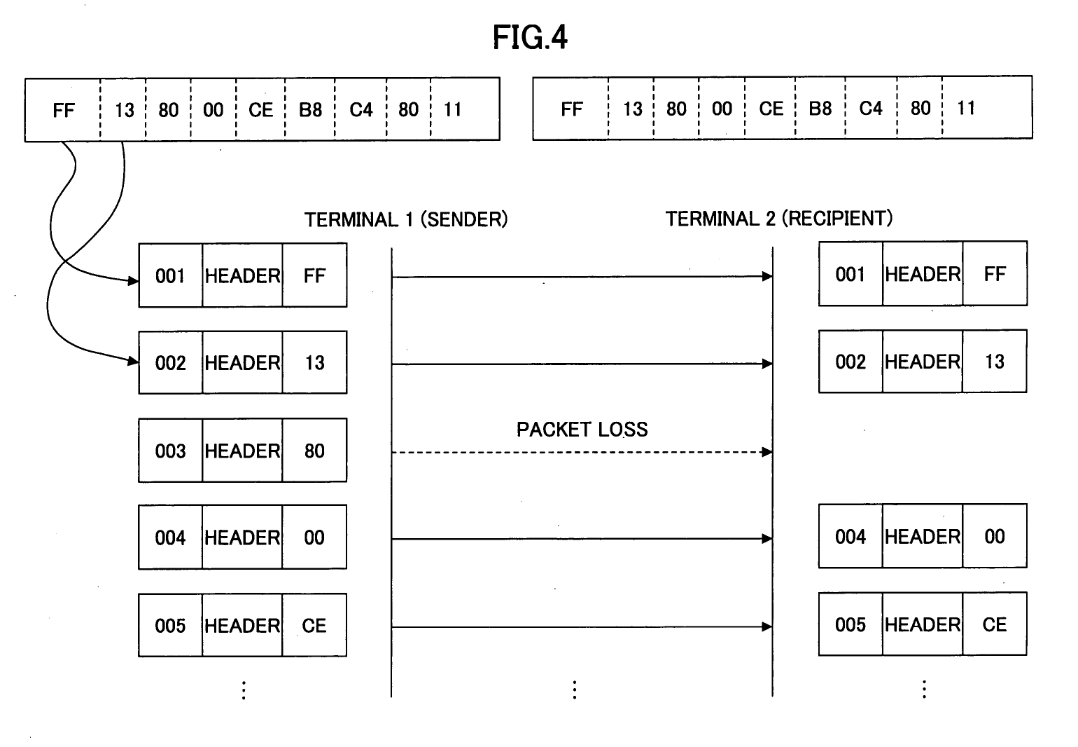

FIG. 4 is a diagram showing the case of dividing and transmitting a facsimile signal from one of the real-time Internet facsimile device 1 and the G3 facsimile device 2 to the other one of the real-time Internet facsimile device 1 and the G3 facsimile device 2. Hereinafter, the real-time Internet facsimile device 1 and the G3 facsimile device 2 may also be referred to simply as terminals 1 and 2, respectively, for convenience of description. For instance, in the case of dividing and transmitting a facsimile signal from the terminal 1 to the terminal 2, as shown in FIG. 4, the control part 10 (FIG. 2) of the terminal 1 divides a facsimile signal FF1380 . . . 8011 into multiple pieces, and adds the IP+UDP header 30, the sequence number 32, and the header 34 and attaches previously transmitted multiple packets to each of the pieces, thereby assembling each piece of the facsimile signal into a packet. The control part 10 of the terminal 1 transmits these packets in order through the compression and decompression circuit 12, the G3 communications control part 20, and the network control part 22 to the terminal 2 via the public network (PSTN). When the control part 10 of the terminal 2 receives the packets in order from the terminal 1 through the network control part 22, the G3 communications control part 20, and the compression and decompression circuit 12, the control part 10 of the terminal 2 connects these packets and stores the connected packets in a storage part 24 (FIG. 2). As described below, if packet loss occurs during the reception of the packets and the lost packet (for instance, the packet of sequence number 003 in the case of FIG. 4) is recoverable from the redundant packets attached to the other packets, the control part 10 of the terminal 2 recovers the lost packet from the redundant packets.

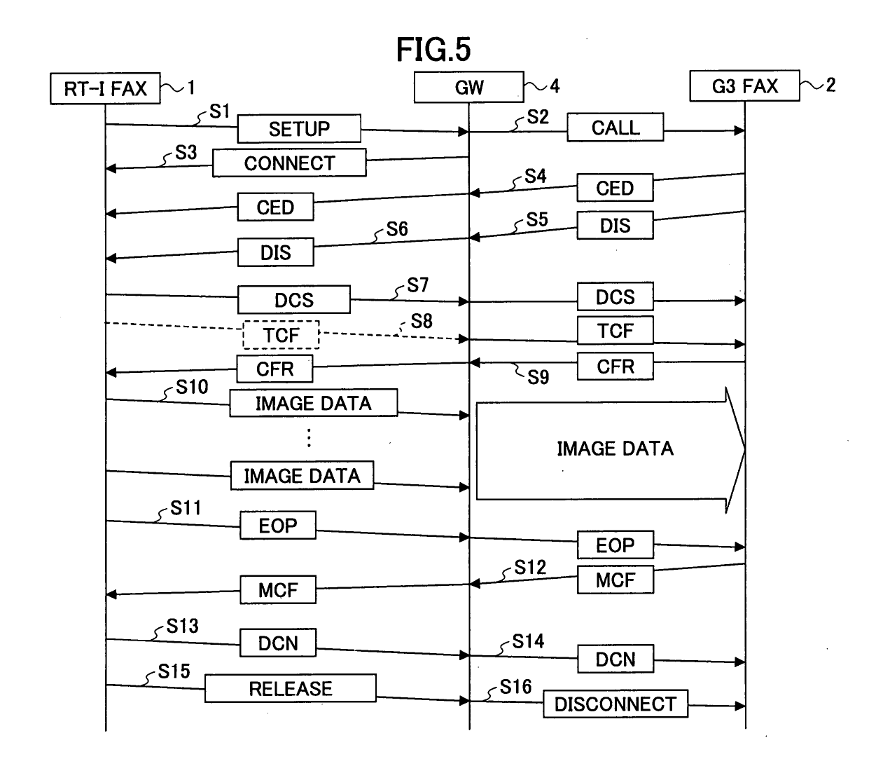

FIG. 5 is a diagram showing a communications sequence of the communications network system of FIG. 1. In step S1 of FIG. 5, the terminal (RT-I FAX) 1 transmits a signal SETUP requesting the terminal (G3 FAX) 2 to set up a connection to the gateway (GW) 4 via the public network (PSTN) and the IP network 3. Receiving the signal SETUP, in step S2, the gateway 4 transmits a calling signal to call the terminal 2 to the terminal 2 via the switch 5 and the public network, thereby establishing a communications path between the terminals 1 and 2. Further, in step S3, the gateway 4 transmits a connection signal CONNECT reporting the setup of the connection of the terminal 2 to the terminal 1.

Receiving the calling signal, in step S4, the terminal 2 transmits a ITU-T Recommendation T.38-compliant predetermined tone signal CED (called station identification) to the terminal 1 via the public network (PSTN), the switch 5, the gateway 4, the IP network 3, and the public network (PSTN). Further, in step S5, the terminal 2 assembles an HDLC frame DIS signal for reporting its standard transmission function into multiple packets as described above, and transmits these packets in order to the terminal 1 via the public network (PSTN), the switch 5, the gateway 4, the IP network 3, and the public network (PSTN). In step S6, the terminal 1 receives the DIS signal and sets its transmission function and modem speed.

Next, in step S7, the terminal 1 assembles an HDLC frame signal DCS (Digital Command Signal) for reporting the transmission function to be used into multiple packets as described above, and transmits these packets in order to the terminal 2 via the public network, the IP network 3, the gateway 4, the switch 5, and the public network. Further, in step S8, the terminal 1 transmits a signal TCF (Training Check Frame) for modem training to the terminal 2 via the public network, the IP network 3, the gateway 4, the switch 5, and the public network. Next, in step S9, the terminal 2 transmits a signal CFR (Confirmation to Receive) for reporting completion of preparation for reception to the terminal 1 via the public network, the switch 5, the gateway 4, the IP network 3, and the public network.

Receiving the CFR signal, in step S10, the terminal 1 assembles image information (data) to be transmitted into multiple packets as described above, and transmits these packets in order to the terminal 2 via the public network, the IP network 3, the gateway 4, the switch 5, and the public network.

When the terminal 1 completes transmission of the image information, in step S11, the terminal 1 assembles an HDLC frame signal EOP (End Of Procedure) indicating the end of the image information transmission into multiple packets as described above, and transmits these packets in order to the terminal 2 via the public network, the IP network 3, the gateway 4, the switch 5, and the public network. Receiving the EOP signal normally, in step S12, the terminal 2 assembles an HDLC frame signal MCF (Message Confirmation) indicating normal completion of the image information reception into multiple packets as described above, and transmits these packets in order to the terminal 1 via the public network, the switch 5, the gateway 4, the IP network 3, and the public network.

Receiving the MCF signal, in step S13, the terminal 1 assembles an HDLC frame signal DCN (Disconnect) for commanding line release into multiple packets as described above, and transmits these packets in order to the terminal 2 via the public network, the IP network 3, the gateway 4, the switch 5, and the public network. In step S14, the terminal 2 receives the DCN signal, and terminates the operation of receiving the image information. In step S15, the terminal 1 transmits a signal RELEASE requesting disconnection of the communications path to the gateway 4 via the public network and the IP network 3 so that in step S16, the communications path with the terminal 2 is disconnected.

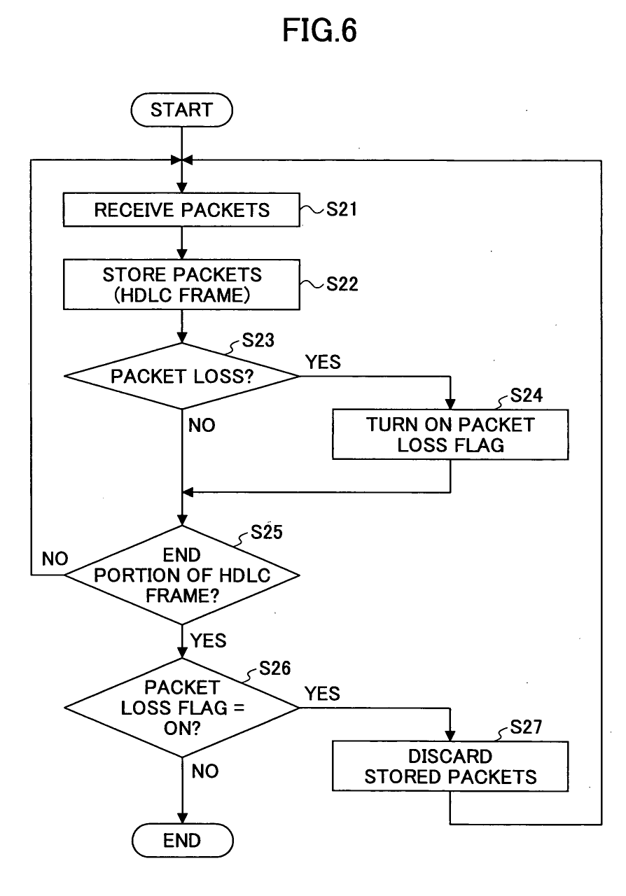

FIG. 6 is a flowchart showing part of the operations flow of a terminal at the time of packet reception according to the first embodiment of the present invention. In step S21 of FIG. 6, the control part 10 of a recipient terminal, for instance, the terminal 2, receives packets in order from a sender terminal, for instance, the terminal 1, through the network control part 22, the G3 communications control part 20, and the compression and decompression circuit 12. Then, in step S22, the control part 10 of the terminal 2 connects (assembles) the packets and stores the connected packets in the storage part 24. In step S23, the control part of the terminal 2 determines whether there is a packet loss by determining whether there is a lost packet and whether the lost packet is recoverable from the redundant packets attached to the other packets. If there is a packet loss (that is, YES in step S23), in step S24, the control part 10 of the terminal 2 turns a packet loss flag ON. In step S25, the control part 10 of the terminal 2 determines whether a packet it has currently received and processed is the end portion of a single HDLC (signal) frame (assembled into multiple packets). In this case, the control part 10 of the terminal 2 determines that the packet is the end portion of a single HDLC frame when the Field-Type of the packet is HDLC_FCS_OK, HDLC_FCS_BAD, HDLC_FCS_OK_SIG_END, or HDLC_FCS_BAD_SIG_END.

If the control part 10 of the terminal 2 determines in step S25 that the received and processed packet is the end portion of a single HDLC frame, in step S26, the control part 10 of the terminal 2 determines whether the packet loss flag is turned ON. If in step S26, the control part 10 of the terminal 2 determines that the packet loss flag is turned ON (that is, YES in step S26), the control part 10 of the terminal 2 determines that part of the signal frame has been lost, and in step S27, discards the connected and stored packets of the signal frame without providing the packets to a protocol processing part 26 (FIG. 2).

If in step S26, the control part 10 of the terminal 2 determines that the packet loss flag is not turned ON (that is, NO in step S26), the control part 10 of the terminal 2 provides the connected and stored packets of the signal frame to the protocol processing part 26. At this point, if there is a lost packet, the control part 10 of the terminal 2 recovers the lost packet using a corresponding one of the redundant packets attached to the other packets.

Thus, if packet loss occurs at the time of receiving a single HDLC frame signal in multiple packets in UDP communications, the HDLC frame signal may be discarded when the end portion of the HDLC frame signal is received. As a result, communications can be performed normally even if packet loss occurs.

Further, if packet loss occurs after receiving an initial HDLC packet at the time of receiving a single HDLC frame signal in multiple HDLC packets in UDP communications, the HDLC frame signal may be discarded when the end portion of the HDLC frame signal is received. As a result, communications can be performed normally even if packet loss occurs.

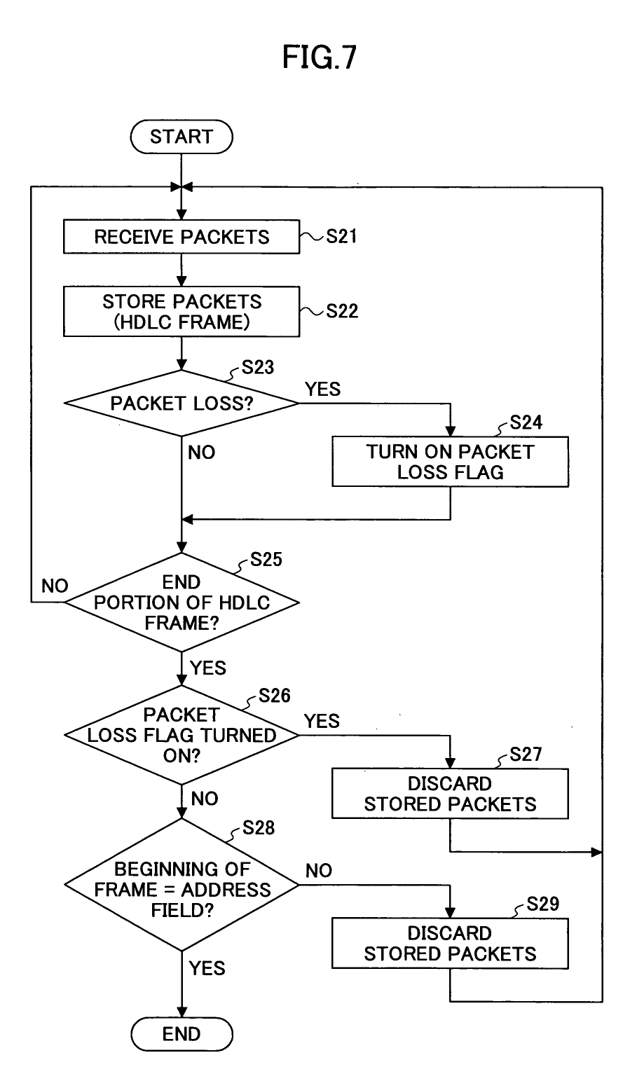

FIG. 7 is a flowchart showing part of the operations flow of a terminal at the time of packet reception according to a second embodiment of the present invention. In the second embodiment, the operation flow of FIG. 7 is performed instead of the operation flow of FIG. 6. In FIG. 7, the same operation as that of steps S21 through S26 of FIG. 6 is performed before step S28. If in step S26, the control part 10 of the terminal 2 determines that the packet loss flag is not turned ON (that is, NO in step S26), in step S28, the control part 10 of the terminal 2 checks the beginning of the stored signal frame assembled by connecting the received packets, and determines whether the beginning is an address field and a control field. If the beginning is not an address field and a control field (that is, NO in step S28), in step S29, the control part 10 of the terminal 2 discards the connected and stored packets of the signal frame without providing the packets to the protocol processing part 26.

If the beginning is an address field and a control field (that is, YES in step S28), the control part 10 of the terminal 2 provides the connected and stored packets of the signal frame to the protocol processing part 26. At this point, if there is a lost packet, the control part 10 of the terminal 2 recovers the lost packet using a corresponding one of the redundant packets attached to the other packets.

Thus, if packet loss may have occurred at the beginning of a single HDLC frame at the time of receiving the HDLC frame in multiple packets in UDP communications, the initial one of the received packets is checked when the end portion of the HDLC frame is received. If the initial one of the received packets is not the beginning of the HDLC frame, the frame signal (received packets) is discarded. As a result, communications can be performed normally even if packet loss occurs.

In the case of multiple frame communications, in step S25 of FIGS. 6 and 7, the control part 10 of the terminal 2 determines whether a packet it has currently received and processed is the end portion of the last one of multiple frames. If YES in step S25, in step S26, the control part 10 of the terminal 2 determines whether the packet loss flag is turned ON. If the control part 10 of the terminal 2 determines in step S26 that the packet loss flag is turned ON (that is, YES in step S26), the control part 10 of the terminal 2 determines that part (a packet) of the multiple frames has been lost, and in step S27, discards the connected and stored packets of the multiple frames without providing the packets to the protocol processing part 26.

In FIGS. 6 and 7, the terminals 1 and 2 are described as a sender terminal and a recipient terminal, respectively. Alternatively, the terminals 1 and 2 may be a recipient terminal and a sender terminal, respectively.

The present invention is not limited to the specifically disclosed embodiments, and variations and modifications may be made without departing from the scope of the present invention. The present invention is applicable in the case of communicating multiple packets into which a single frame signal is divided in a system performing digital communications.

The present application is based on Japanese Priority Patent Application No. 2003-323119, filed on Sep. 16, 2003, the entire contents of which are hereby incorporated by reference.

1. A terminal performing digital communications, wherein:
when packet loss occurs at a time of receiving a plurality of packets into which a single frame of information is divided, the received packets are discarded when a last one of the packets is received.

2. A terminal performing digital communications, wherein:
when packet loss occurs, at a time of receiving a plurality of packets into which a single frame of information is divided, after receiving a first one of the packets, the received packets are discarded when a last one of the packets is received.

3. A terminal performing digital communications, wherein:
when there is a possibility, at a time of receiving a plurality of packets into which a single frame of information is divided, of occurrence of loss of an initial packet of the frame, a first one of the received packets is checked and if the first one of the received packets is not the initial packet of the frame, the received packets are discarded.

4. A method of performing digital communications in which a single frame of information is communicated in a plurality of packets, the method comprising the steps of:
(a) successively receiving the packets of the frame;
(b) storing the received packets;
(c) determining whether there is occurrence of packet loss during said step (a);
(d) determining whether a lost packet is recoverable from redundant packets attached to a rest of the packets when said step (c) determines that there is the occurrence of the packet loss during said step (a); and
(e) discarding the stored packets at a time of receiving a last packet of the frame when said step (d) determines that the lost packet is unrecoverable from the redundant packets attached to the rest of the packets.

5. The method as claimed in claim 4, wherein the packet loss occurs after receiving an initial packet of the frame.

6. The method as claimed in claim 4, further comprising the steps of:
(f) determining, at the time of receiving the last packet of the frame, whether a first one of the stored packets is an initial packet of the frame when said step (d) determines that the lost packet is recoverable from the redundant packets attached to the rest of the packets; and
(g) discarding the stored packets when said step (f) determines that the first one of the stored packets is not the initial packet of the frame.
